(19) United States
(12) Patent Application Publication
(10) Pub. No.: US 2026/0142993 A1
(43) Pub. Date: May 21, 2026

(54) SYSTEMS SECURITY DEVICE WITH SENSING CAPABILITY TO TAKE ACTION BASED ON BI-DIRECTIONAL TRAFFIC

(71) Applicant: Stifel Ridge LLC, Leesburg, VA (US)

(72) Inventors: Robert Edwin WOODS, III, Austin, TX (US); Robert Parker WOODS, Austin, TX (US)

(21) Appl. No.: 19/397,216

(22) Filed: Nov. 21, 2025

Related U.S. Application Data
(60) Provisional application No. 63/723,266, filed on Nov. 21, 2024.

(51) Int. Cl. H04L 9/40

(52) U.S. Cl. CPC H04L 63/1425; H04L 63/1441

(57) ABSTRACT

The information and operational technology systems security device is an independent decision capability for monitoring a systems communication traffic using a separate processor system with the ability to signal actions to allow or disallow communication from and to a protected system or system components. The device has system processors and components that are not network and data directly connected to the monitored system but uses an active or passive sensing capability to observe traffic bi-directionally to determine if the communication/packets meet criteria for an action. The actions could include the ability to reroute, duplicate, allow communications to continue, disallow communications into or out of the monitored system, or elicit a predetermined response for all or part of the protected system's communications traffic. The device controls the communications interfaces of the protected system(s), and the decision-making processor is programmed to meet user criteria and security requirements of the protected system.

### CROSS-REFERENCE TO RELATED APPLICATIONS

The present patent application claims priority to U.S. Provisional Application No. 63/723,266, filed on Nov. 21, 2024 and titled “Systems Security Device”, the contents of which are incorporated by reference in their entirety.

### FIELD

One or more embodiments described herein relate to cybersecurity systems.

### BACKGROUND

Hackers gain access to computing systems through many known tactics, methods, and practices via connections including standard inter-or intranet protocols (including ports with 802.X and common operating system protocols) to conduct their malicious activities. With the threat landscape against informational and operational technology systems continuing to get worse, a need exists for improved solutions.

### BRIEF DESCRIPTION OF THE DRAWINGS

FIG. 1 is a system block diagram of a cybersecurity system, according to an embodiment.

FIG. 2 is a system block diagram of a cybersecurity system, according to another embodiment.

FIG. 3 is a system block diagram of a cybersecurity system, according to yet another embodiment.

### DETAILED DESCRIPTION

Some embodiments achieve protection of communications systems by isolating them using a separate security device(s) that has the capability that is independent of the protected communications system and that is itself not data or network connected to the protected system. In some instances, some embodiments will not be connected to anything except their own components and are only able to be updated by someone with physical access to the invention. In some embodiments, the software supporting the operations is microcode and typically has a reduced-instruction-set kernel module packet-inspection capability and as needed additional software can include machine learning (from known or determined baselines) and artificial intelligence capabilities in the protected communication system connected device processors.

Some embodiments can be a completely new class of cybersecurity control when compared to NIST Special Publication 800-053. This is a “passport” device as the packet-by-packet inspection creates validation and authentication at a new level of protection to achieve zero trust capabilities that can't be manipulated.

The independent processor of an embodiment (that is not data connected) views packet information packet-by-packet and determines if the packet can be transited to another network component or the protected communication system if all rules/conditions are met. This inspection of network traffic can happen in one system/network location/node or along multiple systems/network locations/nodes, with one or more devices described herein, each making decisions based on part or all of the available header or payload data of a packet(s).

The arrangement in some embodiments of isolated and connected (to the protected communications system) processors stops unauthorized access and lateral movement even if a protected communications system has already been compromised. The software analyzes and determines whether to allow or not allow transceivers to transmit or receive packet by packet or file by file. Some embodiments are also protected to ensure no hacker can compromise the embodiments themselves including, for example, by using power buffering to eliminate power line attacks. Known firewalls, routers, and switches suffer from being accessible, just like the communications systems they are supposed to protect, and therefore fall victim to compromise and manipulation. In contrast, some embodiments do not suffer from that. The independent monitoring capability allows for trust in data and data privacy attributes.

By controlling boundaries and interfaces of some embodiments with a connect “on command” ability using one or more independent/unalterable rule sets approach, the protected communications system and the device of some embodiments have time to detect and control data and network traffic differently than the persistent 24/7 365 connection that is the typically known method. The ability to truly isolate and monitor data/network traffic provides a highly capable solution to the vulnerability problem of known systems. Some embodiments include a hardware and software security and/or controller device. The software can include, for example, artificial intelligence (AI) to be executed on processors that are on the protected or unprotected side of the series of processors. Processors on the inter- or intranet side of connection are unprotected while those “behind” the connection facing the protected system are protected from unauthorized access, though processor(s) on this side may receive unauthorized data/network traffic from latent corruption present on the protected system. AI is to act on trusted data and some embodiments provide the opportunity to protect the data and the AI processing. Like AI, the same applies to Machine Learning (ML) and other deep packet inspection and other software-based security measures. Isolated processing and programmable independent rule sets can enable all these desired security activities. The result is that hackers cannot access, map, scan, or “see” their targeted system. Blinding the hackers will likely make them go to another targeted system, and it will also not allow them to trust in the target systems packets responses. This invention can also include embodiments that obfuscate or create capabilities that are deceptive to hackers including golden goose or honeypot capabilities that can lead them to believe their attack was successful when it is not. This may cause malicious actors to lose trust in their ability to access systems previously accessible to them. Some embodiments are applicable, for example, to protecting systems from hacking to include computers, servers, internet of things (IoT) devices, autonomous systems, industrial control systems, vehicles, smart phones, and internet infrastructure including cloud or on premises data centers.

Because interfaces and boundaries control data and traffic in this way, some embodiments provide for secure file transfer protocols and processes. Sequencing the connections and providing for inspection and isolated control of files, to include the encryption and decryption, allows for trust in data as even data poisoning is detectable prior to any protected system receiving packets/files.

Some embodiments have special zero trust attributes to include the use of special cryptographic and hash techniques to validate and authenticate users and traffic packet by packet, and the way the device systems are isolated allows for protection of algorithms and keys. Therefore, key management and algorithm protection can be achieved in contrast with known methods that have been compromised. Since one or more embodiments completely isolate the keys and algorithms in a middle processor and the communication links are commanded by an independent processor then the encryption and decryption is able to be done while completely separated from the protected system. The file/packet data flows through to the separated device processor where the encryption and decryption are not exposed to either the protected system or the “outside” intra- or internet world from the protected system.

The connection between the “outside-facing” elements of the device and the intranet or internet as well as the connection between the protected system and the device can be, for example, a commercial off the shelf (e.g., 802.x) port connection or a customized connector. The connections will allow, for example, for any standard connection types or combination between device elements to include optical and copper. Radio frequency communications (e.g., wi-fi® and Bluetooth®) can be allowed on the unprotected processor or port (e.g., 117A or 112A) of the device and not on the protected processor or port of the device (e.g., 117B or 112B). In one or more embodiments, side taps are not allowed for the independent processors or any processor directly connected to the protected system. Part of the micro code also can be, for example, a script to ensure ports that are part of the protected system are disabled continuously except for the port(s) connected to the device. This may also include the deletion of unnecessary drivers for unauthorized ports. Security requirements can dictate, for example, based on risk, the selection of the packet inspection software and the connection. Processors and architecture can be selected for bandwidth and capability to meet client's requirements for reliability function.

Some embodiments enable routing and dynamic routing that can allow hiding of IP addresses and locations to deceive hackers. The ability to view actively and passively the traffic of a protected system can allow the software and programmed rule sets to operate autonomously and achieve the routing and responses determined.

A user can combine more than one device with additional rule sets or to control another device to change data without the deciding processor being connected. When used individually or in a series/systematic way then the user can achieve micro and macro segmentation, which will create security unlike any other known solution.

Discrimination software code to packet-by-packet inspect with options for layers 2, 3, and above of the Open Systems Interconnection (OSI) model can create the opportunity to display and decide on a packet-by-packet basis. The independent processor's microcode takes away the ability to bypass the inspection. Information Technology (i.e., Enterprise) and Operational Technology (i.e., Industrial Control Systems) protocols can be accommodated for in this device.

Isolating using filtering can allow client specified frequencies (or predetermined frequencies), and not other frequencies. Hackers can use frequency manipulation to hack, and the ability of one or more embodiments to detect and filter for any part of the spectrum can ensure that no additional/unauthorized frequencies are being used to compromise to protect/deny unauthorized access. The detection of the off-frequency attempts can be controlled, for example, by the independent processor so it can take action to stop network traffic and data flows as the programming dictates.

This capability is anticipated to be “baked in” to product security offerings which is why the component level and reducing the size of this to using smaller chip sets is anticipated.

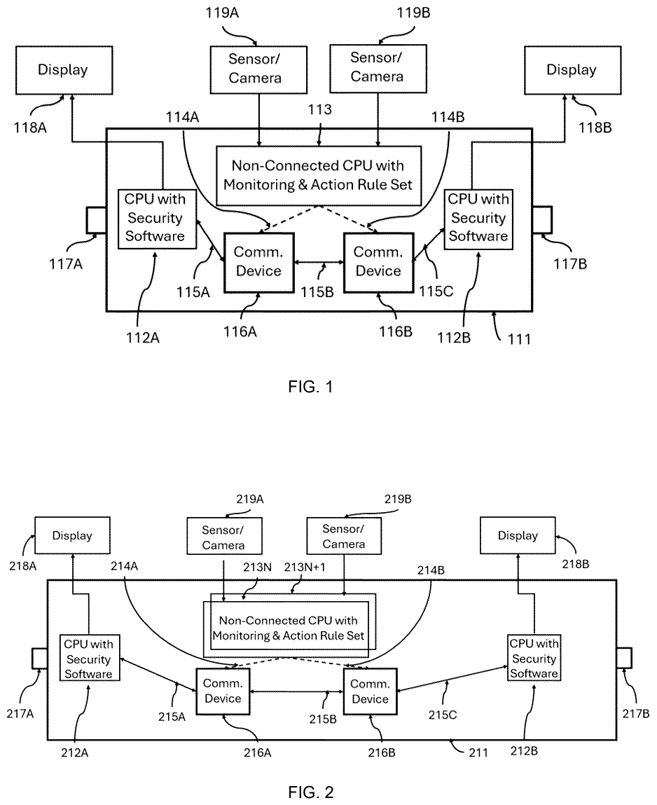

FIG. 1 is a system block diagram of a cybersecurity system, according to an embodiment. As shown in FIG. 1, cybersecurity system includes various components on the “unprotected” intranet- or internet-facing side of the connection to an external device and/or network (defined by physical port 117A and CPU with security software 112A): CPU with security software 112A, communication device 116A, connection 115A, display 118A, and physical port 117A. Cybersecurity system also includes various components on the “protected” side of the connection closest to the system being protected from unauthorized access: non-connected CPU with monitoring and action rule set 113, CPU with security software 112B, communication device 116B, connection 115C, connection 114A, connection 114B, display 118B, sensor/camera 119A, sensor/camera 119B, and physical port 117B. As a non-connected CPU, the security settings on this processor are protected from unauthorized access and altering. This also substantially protects security software residing on CPU 112B.

Physical port 117A can be, for example, a physical port according to standards such as RJ45, USB, SFP, etc. Physical port 117A can connect an Intranet or the Internet to the cybersecurity device. In use data/network traffic can then flow from physical port 117A to CPU with security software 112A, which can inspect the data/network traffic.

The CPU with security software 112A can be connected to a display/output 118A to show the user various data and telemetry about the CPU 112A and network traffic information (e.g., packets, logs, Layer-2 data, and Layer-3 data). This CPU 112A can also perform, for example, security checks and deep packet inspection as desired. The different micro code on CPUs 112A, 112B, and 113, are at the operating system kernel level and coded to ensure they are not able to be bypassed by network traffic.

The sensor/camera 119A can observe the display 118A and send the output from sensor/camera 119A to the non-connected CPU with monitoring and action rule set 113. CPU 113 can selectively send power via connections 114A and 114B (e.g., each a power cable) to one or both communication devices 116A and 116B. Communication devices 116A and 116B can be, for example, light emitting diode (LED)-Light Receiving Diode (LRD) pairs or other communication devices; the power sent from CPU 113 to communication devices 116A and 116B (e.g., the LED/LRD pairs) can control the duration of the waveform from CPU 113 to start and stop traffic through communication devices 116A and 116B. This prevents additional packets or frequencies from being transmitted between CPU 112A and CPU 112B via communication devices 116A and 116B when communication devices 116A and 116B do not receive power from CPU 113. The connection 115B is then energized, allowing data/network traffic to flow between the two CPUs with security software 112A and 112B. Additional security checks are performed on data/network traffic at CPU with security software 112B. Because this CPU with security software 112B is behind the connection, various actors cannot map or “see” the security software residing on this component.

FIG. 2 is a system block diagram of a cybersecurity system, according to another embodiment. The cybersecurity system of FIG. 2 is similar to the cybersecurity system of FIG. 1 except that the non-connected CPU with monitoring and action rule set 113 of FIG. 1 is replaced with multiple non-connected CPUs each with monitoring and action rule set 213N and 213N+1. Including multiple non-connected CPUs in this embodiment may have several effects including hosting additional rule sets and criteria on a non-connected CPU. The remaining devices of the cybersecurity system of FIG. 2 can be the same as or similar to the like numbered remaining devices of the cybersecurity system of FIG. 1 (e.g., physical port 217A of FIG. 2 can be the same as or similar to physical port 117A of FIG. 1, CPU with security software 212A of FIG. 2 can be the same or similar as CPU security software 112A of FIG. 1, etc.).

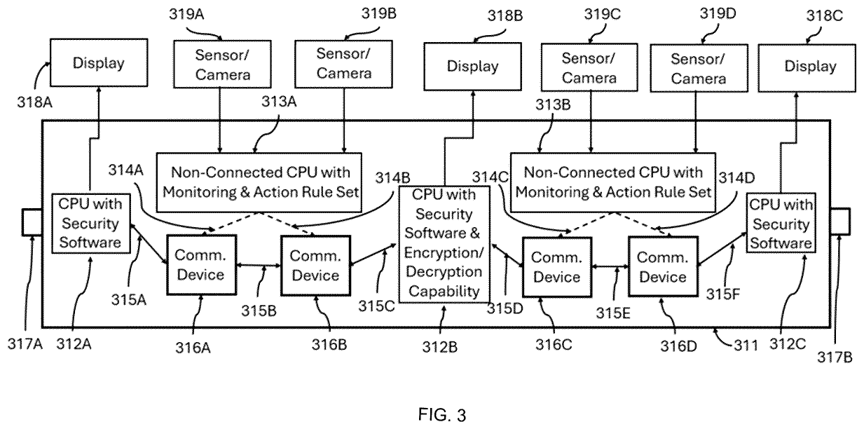

FIG. 3 is a system block diagram of a cybersecurity system, according to yet another embodiment. As shown in FIG. 3, cybersecurity system includes various components on the “unprotected” intranet- or internet-facing side of the connection: CPU with security software 312A, communication device 316A, connection 315A, display 318A, and physical port 317A. Cybersecurity system also includes various components on the “protected” side of the connection: non-connected CPUs each with monitoring and action rule set 313A and 313B; CPU with security software and encryption/decryption capability 312B; communication devices 316B, 316C and 318D; connections 315B, 315C, 315D, 315E and 315F; connections 314A, 314B, 314C and 314D; displays 318B and 318C; sensors/cameras 319A, 319B, 319C and 319D; and physical port 317B. As non-connected CPUs 313A and 313B, the security settings on these processors are protected from unauthorized access and altering. This also substantially protects security software residing on CPU 312B.

Physical port 317A can be, for example, a physical port according to standards such as RJ45, USB, SFP, etc. Physical port 317A can connect an Intranet or the Internet to the cybersecurity device. In use data/network traffic can then flow from physical port 317A to CPU with security software 312A, which can inspect the data/network traffic.

The CPU with security software 312A can be connected to a display/output 318A to show the user various data and telemetry about the CPU 312A and network traffic information (e.g., packets, logs, Layer-2 data, and Layer-3 data). This CPU 312A can also perform, for example, security checks and deep packet inspection as desired. The different micro code on CPUs 312A, 312B, and 312C, are at the operating system kernel level and coded to ensure they are not able to be bypassed by network traffic.

The sensor/camera 319A can observe the display 318A, and can send the output from sensor/camera 319A to the non-connected CPU with monitoring and action rule set 313A. CPU 313A can selectively send power via connections 314A and 314B (e.g., each a power cable) to one or both communication devices 316A and 316B based on the monitoring and action rule set by CPU 313A. Communication devices 316A and 316B can be, for example, light emitting diode (LED)-Light Receiving Diode (LRD) pairs or other communication devices; the power sent from CPU 313A to communication devices 316A and 316B (e.g., the LED/LRD pairs) can control the duration of the waveform from CPU 313A to start and stop traffic through communication devices 316A and 316B. This prevents additional packets or frequencies from being transmitted between CPU 312A and CPU 312B via communication device 316A and communication device 316B when communication devices 316A and 316B do not receive power from CPU 313A. The connection 315B is then energized, allowing data/network traffic to flow between the CPU with security software 312A to CPU with security software and encryption/decryption capability 312B. Additional security checks can be performed on data/network traffic at CPUs with security software 312B.

Similarly, sensor/camera 319C can observe display 318B, and send the output from sensor/camera 319C to the non-connected CPU with monitoring and action rule set 313B. CPU 313B can selectively send power via connections 314C and 314D (e.g., each a power cable) to one or both communication devices 316C and 316D based on the monitoring and action rule set by CPU 313B. Communication devices 316C and 316D can be, for example, light emitting diode (LED)-Light Receiving Diode (LRD) pairs or other communication devices; the power sent from CPU 313B to communication devices 316C and 316D (e.g., the LED/LRD pairs) can control the duration of the waveform from CPU 313B to start and stop traffic through communication devices 316C and 316D. This prevents additional packets or frequencies from being transmitted between CPU 312B and CPU 312C via communication device 316C and communication device 316D when communication devices 316C and 316D do not receive power from CPU 313B. The connection 315E is then energized, allowing data/network traffic to flow between the CPU with security software & encryption/decryption capability 312B to CPU with security software 312C. Additional security checks can be performed on data/network traffic at CPUs with security software 312C.

Because these CPUs with security software 312B and 312C are behind the connection, various actors cannot map or “see” the security software residing on this component. CPU 312B has an encryption/decryption capability that cannot be altered by a malicious entity such as a hacker due to non-addressable CPUs 313A and 313B, which are associated with ingress and egress, respectively, and which control the selective actuation of communication devices 316A and 316B and communication devices 316C and 316D, respectively.

Traffic then flows through physical port 317B to the protected system (not shown). As a bidirectional device allowing data/network traffic both into and out of the protected system, this process can be performed in reverse with the protected system initiating the flow of data and controlling communication devices 316A through 316D to allow the flow of data. For instance, sensor/camera 319D can observe display 318C, and send the output from sensor/camera 319D to the non-connected CPU with monitoring and action rule set 313B. The displays 318B and 318C and sensors/cameras 319B through 319D behind the connections, is like the functionality described in display 318A and sensor/camera 319A.

Although not explicitly shown, it should be understood that each of the CPUs, communication devices, displays, and sensor/cameras can each be associated with an interconnection of a processor (e.g., configured to execute software/code/instructions stored in memory), memory (e.g., configured to store data, traffic data, network data, software/code/instructions, etc.) and any other components appropriate for that device (e.g., a lens, sensor/detector, etc. for a sensor/camera). For example, although FIGS. 1-3 refer to various CPUs that have security software, monitoring and action rule sets and/or security software and encryption/decryption capability(ies); each such CPU can include a processor and a memory storing software/code/instructions related to the functionality for that CPU.

All combinations of the foregoing concepts and additional concepts discussed herewithin (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The term “automatically” is used herein to modify actions that occur without direct input or prompting by an external source such as a user. Automatically occurring actions can occur periodically, sporadically, in response to a detected event (e.g., a user logging in), or according to a predetermined schedule.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An apparatus, comprising:
a first processor configured to inspect data from a first network and to output a representation of the inspection of the data;
a display coupled to the first processor and configured to display the representation of the inspection of the data;
a sensor not coupled to the first processor nor the display, the sensor configured to capture the display of the representation of the inspection of the data and send a signal associated with the display of the representation of the inspect of the data; and
a second processor coupled to the sensor and not communicatively coupled to the first processor nor the display, the second processor configured to receive the signal associated with the display of the representation of the data, the second processor configured to selectively send power based on a determination from user requirements and criteria by the second processor.

2. The apparatus of claim 1, wherein the second processor is configured to receive an input from the sensor and configured to determine actions on network or data traffic of a protected system coupled to the second processor based on the input and a system parameter.

3. The apparatus of claim 1, further comprising:
a communication device coupled to but not controlled by the first processor with a bi-directional connection and coupled to the second processor with a connection configured to receive the power and not data from the second processor and not sending data to the second processor.

4. The apparatus of claim 1, further comprising:
a first communication device coupled to the first processor with a bi-directional connection and coupled to the second processor configured to receive power and not data from the second processor and not sending data to the second processor; and
a second communication device coupled to another processor, the second communication device having a bi-directional connection and coupled to the second processor with a connection, the second communication device configured to receive power and not data from the second processor and not sending data to the second processor.

5. The apparatus of claim 1, further comprising:
a first communication device coupled to the first processor with a bi-directional connection and coupled to the second processor configured to receive power and not data from the second processor and not sending data to the second processor,
the second processor configured to send power to the first communication device based on the data from the representation of the inspection meeting criteria determined by the second processor.

6. The apparatus of claim 1, further comprising:
a first communication device coupled to the first processor with a bi-directional connection and coupled to the second processor configured to receive power and not data from the second processor and not sending data to the second processor;
a second communication device coupled to another processor with a bi-directional connection and coupled to the second processor with a connection, the second communication device configured to receive power and not data from the second processor and not sending data to the second processor,
the second processor configured to send power to at least one of the first communication device or the second communication device based on the data from the representation of the inspection meeting criteria determined by the second processor to allow bidirectional communication between the first processor and another processor coupled to the second communication device.

7. The apparatus of claim 1, further comprising:
a third processor coupled to the first processor and not the second processor, the third processor configured to inspect data from at least one of (1) the first network coupled to the first processor or (2) a second network and to output a representation of the inspection of the data from the first network or the second network; and
a display coupled to the third processor and configured to display the representation of the inspection of the data from the second network.

8. The apparatus of claim 1, further comprising:
a first communication device coupled to the first processor with a bi-directional connection and coupled to the second processor configured to receive power and not data from the second processor and not sending data to the second processor; and
a third processor coupled to the first processor via the first communication device and not coupled to the second processor, the third processor configured to receive data from a first network via the first processor after the first communication device receives power from the second processor, the third processor configured to inspect and then send the data from the first network to a protected system.
